(19) United States
(12) Patent Application Publication
(10) Pub. No.: US 2025/0336275 A1
(43) Pub. Date: Oct. 30, 2025

(54) VIDEO BEZEL FOR AUTOMATED PAYMENT SYSTEMS

(71) Applicant: Crane Payment Innovations, Inc., Malvern, PA (US)

(72) Inventors: Gareth Edward Tumblety, Horwich, Bolton (GB); Christopher Stephen Carmine, Chalfont, PA (US)

(21) Appl. No.: 18/871,471

(22) PCT Filed: Jun. 7, 2023
(86) PCT No.: PCT/US2023/068083

§ 371 Date: Dec. 3, 2024

Related U.S. Application Data
(60) Provisional application No. 63/366,225, filed on Jun. 10, 2022.

(51) Int. Cl. G07G 1/00; G07G 1/01

(52) U.S. Cl. CPC G07G 1/0018; G07G 1/01

(57) ABSTRACT

An automated payment system comprising a housing, one or more payment interfaces, a bezel disposed on a user-facing side of the housing, and a display screen coupled to the bezel, the display screen including one or more apertures each formed through a portion of the display screen, wherein each of the one or more apertures corresponds to one of the one or more payment interfaces, and wherein the display screen is configured to display a plurality of images. The automated payment system can also include at least one sensor and at least one processor. The at least one sensor is configured to capture at least one image of a user, and wherein, based on a predicted payment intent of the user, the processor causes transmission of a signal to illuminate a light source corresponding to one of the one or more payment interfaces.

### CROSS-REFERENCE TO RELATED APPLICATIONS

This application is a 371 National Stage of International Application No. PCT/US2023/068083, filed Jun. 7, 2023, which claims priority to U.S. Provisional Patent Application No. 63/366,225, filed Jun. 10, 2022, the disclosures of which are incorporated herein by reference.

### TECHNICAL FIELD

This disclosure relates generally to automated payment systems. More specifically, this disclosure relates to a video bezel for automated payment systems.

### BACKGROUND

Automated payment systems are now desired to have payment machines that are integrated into their design. Many current payment machines are “bolt on/poke through” accessories with no integration with the overall system design. Further, customizing the look of current payment machines is cost prohibitive, requiring new components and tooling, and possibly new cashless payment certifications for every customer. Additionally, current automated payment systems with multiple payment interfaces or slots suffer from a secondary problem of “slot confusion.” With slots for notes, coins, and cards all closely placed and similar in appearance, it is common for consumers to place cards in note slots, coins in card slots, and so on. This leads to consumer frustration and increased system support costs. A common approach is to use labels, but often people do not read them. Another approach is to use mechanical interlocks to prevent the “wrong” items from being inserted, but they 1) are mechanically complicated, 2) are not fool proof, and 3) generally do not prevent the issue, only limit the damage.

### SUMMARY

This disclosure provides a video bezel for automated payment systems.

In one example embodiment, an automated payment system includes a housing, one or more payment interfaces, a bezel disposed on a user-facing side of the housing, and a display screen coupled to the bezel, the display screen including one or more apertures each formed through a portion of the display screen, wherein each of the one or more apertures corresponds to one of the one or more payment interfaces.

In one or more of the above examples, the display screen is configured to display a plurality of images.

In one or more of the above examples, the automated payment system further includes at least one processor and at least one sensor.

In one or more of the above examples, the at least one sensor is disposed through another aperture formed through another portion of the display screen.

In one or more of the above examples, the at least one sensor is configured to detect ambient lighting conditions of an environment external to the housing, wherein, based on the detected ambient lighting conditions, the at least one processor adjusts at least one of a color temperature and a brightness of the display screen.

In one or more of the above examples, the at least one sensor is configured to detect a presence of a user, and wherein the at least one processor adjusts at least one of the color temperature, the brightness, and a content of the display screen based on the detected presence of the user.

In one or more of the above examples, the at least one sensor is configured to capture at least one image of a user, and wherein, based on a predicted payment intent of the user, the processor causes transmission of a signal to illuminate a light source of one of the one or more payment interfaces.

In one or more of the above examples, the one or more payment interfaces include one or more of a banknote payment interface, a coin payment interface, a card payment interface, and a near field communications (NFC) interface.

In one or more of the above examples, the predicted payment intent includes a prediction, based on the at least one image of the user by the at least one sensor, of a payment type intended for use by the user in a transaction using the automated payment system.

In one or more of the above examples, the plurality of images wraps around the one or more apertures.

In another example embodiment, a method of an automated payment system includes detecting, by at least one sensor of the automated payment system, a presence of a user, adjusting, by at least one processor of the automated payment system, based on the detected presence of the user, at least one of a color temperature and a brightness of a display screen coupled to a bezel of the automated payment system, capturing, by the at least one sensor, at least one image of the user, predicting, by the at least one processor, a payment intent of the user, and causing, by the at least one processor, transmission of a signal to illuminate a light source of one of one or more payment interfaces disposed adjacent to corresponding apertures formed through the display screen.

In another example embodiment an apparatus includes a bezel operable to attach to a user-facing side of a housing of a payment machine, at least one sensor configured to detect environmental conditions external to the housing of the payment machine, and a display screen coupled to the bezel, the display screen including one or more apertures each formed through a portion of the display screen, wherein each of the one or more apertures corresponds to a payment interface of the payment machine.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication or interaction between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), electrically erasable programmable read only memory (EEPROM/E2PROM), random access memory (RAM), ferroelectric RAM (FRAM), a hard disk drive, a compact disc (CD), a digital video disc (DVD), or any other type of volatile/non-volatile/memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIGS. 1A-1D illustrate examples of payment machines in accordance with this disclosure;

FIGS. 2A-2D illustrates an example automated payment system with a video bezel in accordance with this disclosure;

FIGS. 3A and 3B illustrate another example automated payment system with a video bezel in accordance with this disclosure;

FIGS. 4A, 4B, and 4C illustrate another example automated payment system with a video bezel in accordance with this disclosure;

FIG. 5 illustrates an example communications system of an automated payment system in accordance with this disclosure;

FIG. 6 illustrates another example communications system of an automated payment system in accordance with this disclosure;

FIG. 7 illustrates a customer intent and payment interface accentuation process in accordance with this disclosure;

FIGS. 8A-8E illustrate a display screen in accordance with this disclosure;

FIG. 9 illustrates an example electronic device in accordance with this disclosure; and

FIG. 10 illustrates another example electronic device in accordance with this disclosure.

### DETAILED DESCRIPTION

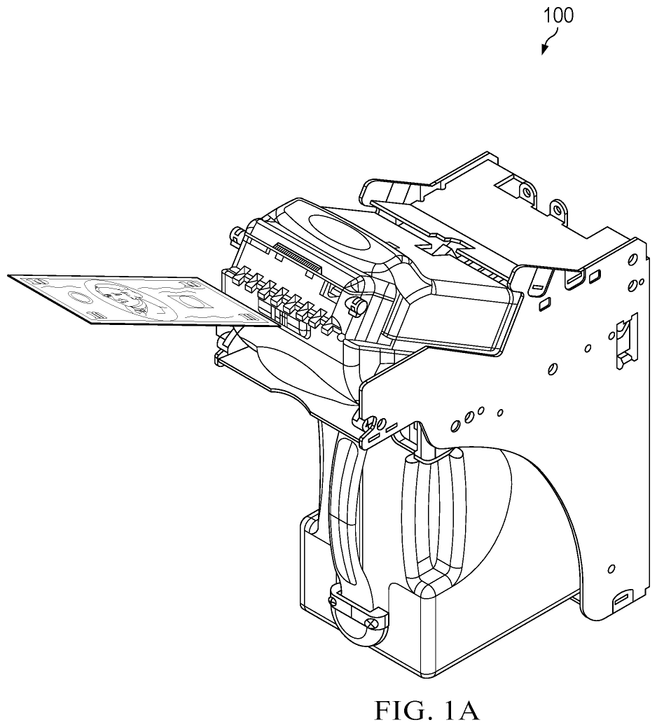

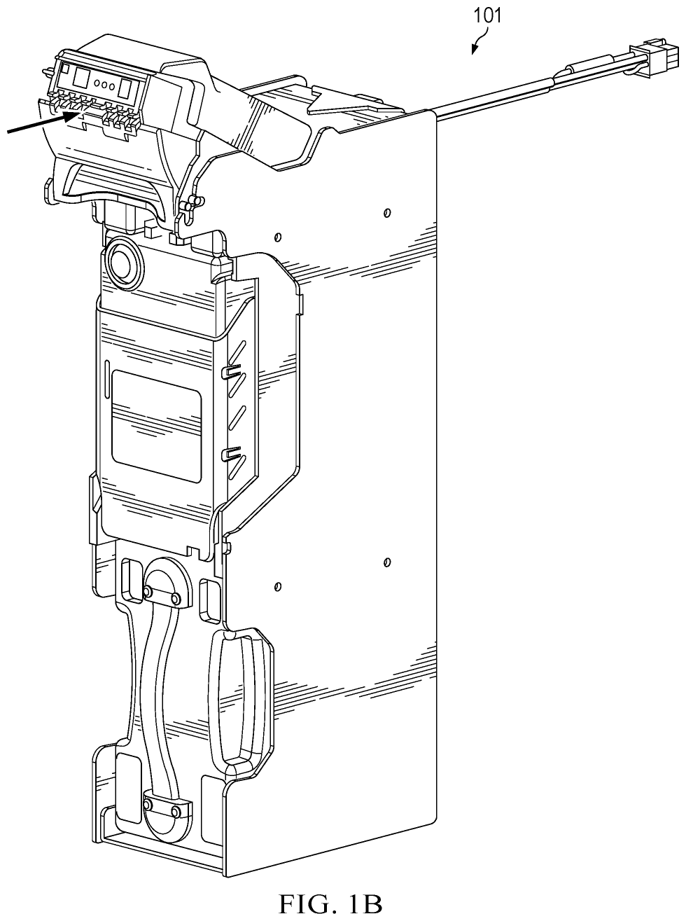

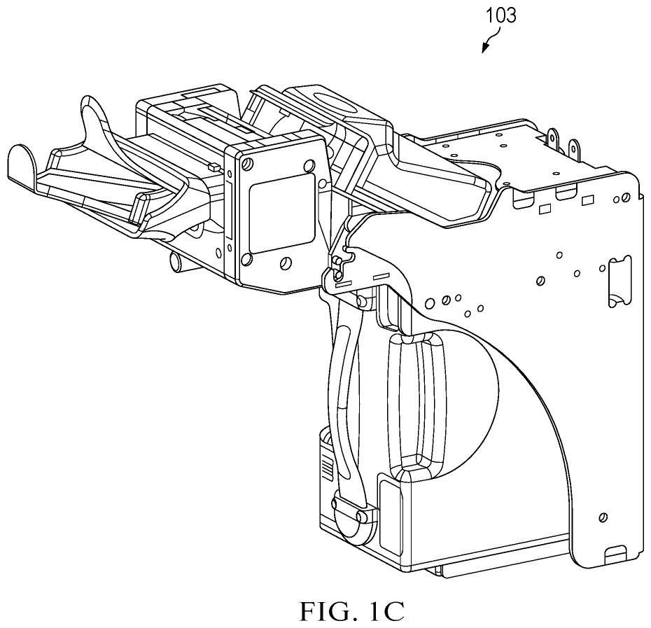

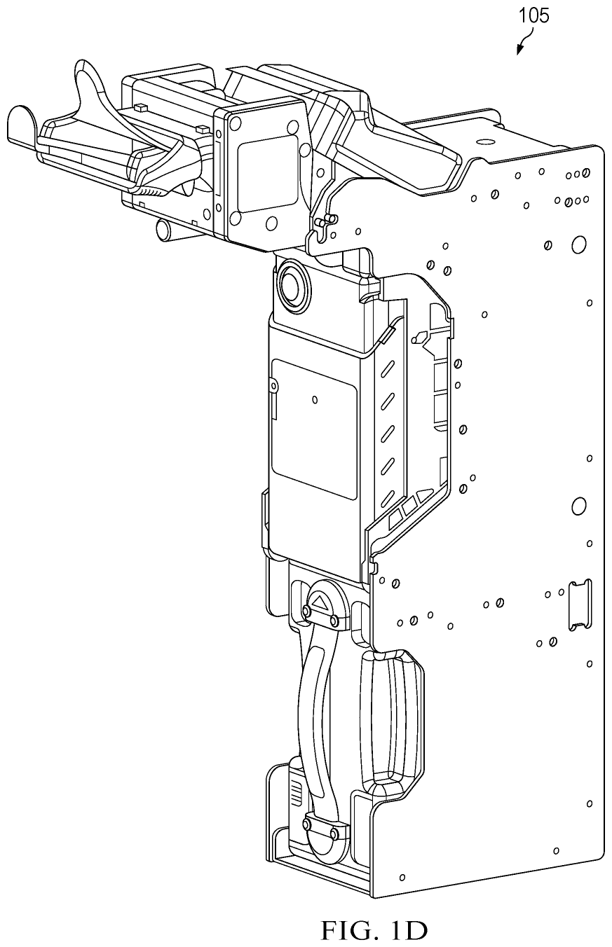

FIGS. 1A through 10, discussed below, and the various embodiments used to describe the principles of the present disclosure in this patent document are by way of illustration only and should not be construed in any way to limit the scope of the disclosure. Those skilled in the art will understand that the principles of this disclosure may be implemented in any suitably arranged device or system.

As used throughout this specification, the terms currency denomination, denomination of currency, valuable document, currency bill, bill, banknote, note, bank check, paper money, paper currency, coin, coinage, and cash may be used interchangeably herein to refer to a type of a negotiable instrument or any other writing that evidences a right to the payment of a monetary obligation, typically issued by a central banking authority. Payment acceptor and coin acceptor may be used interchangeably herein to refer to a type of monetary acceptor unit that may verify inserted banknote in a banknote acceptor or coin in coin acceptor. Payment acceptor may comprise both a banknote acceptor and coin acceptor and other electronic payment acceptance devices. Payment acceptor may include either of a banknote acceptor or a coin acceptor; payment acceptor may or may not comprise electronic payment acceptance devices. Payment acceptor may also comprise a credit card payment interface and/or a near-field communication (NFC) payment interface (e.g., including an NFC antenna) that can interact with another device, such as a mobile device (e.g., a smartphone using APPLE PAY or GOOGLE PAY) to perform payment transactions.

FIGS. 1A-1D illustrate schematic views of example payment machines, e.g., payment acceptors and payment deposit-withdrawal machines in accordance with various embodiments of the present disclosure. FIG. 1A illustrates an example of a payment acceptor machine 100 in accordance with various embodiments of the present disclosure. FIG. 1B illustrates an example of a payment deposit-withdrawal machine 101 in accordance with various embodiments of the present disclosure. FIG. 1C illustrates an example of a payment acceptor machine 103 in accordance with various embodiments of the present disclosure. FIG. 1D illustrates an example of a payment deposit-withdrawal machine 105 in accordance with various embodiments of the present disclosure.

FIG. 1A shows a banknote acceptor machine 100 configured to verify the authenticity of the inserted banknote. The banknote acceptor machine 100 generally has an acceptor head or banknote feeder, a banknote transport system, and a removable banknote storage unit. Inserted banknotes are generally authenticated in a banknote accepting module using various sensors, once the banknote is deemed authentic and deemed acceptable the banknote is transported further into the banknote acceptor machine using the banknote transport system into the removable banknote storage unit.

FIG. 1B illustrates a banknote deposit-withdrawal machine 101 in accordance with various embodiments of the present disclosure. In addition to a banknote accepting module or banknote feeder, a banknote transport system, and a removable banknote storage unit as shown in FIG. 1A, the banknote deposit-withdrawal machine 101 illustrated in FIG. 1B comprises a banknote recycling module that allows the unit to provide banknotes back to the customer. For example, the banknote deposit-withdrawal machine 101 could be used in an automated payment system where a customer presents a high denomination banknote to purchase goods or services that are valued more than the value of purchased goods or services and the unit provides lower denomination banknotes to provide change to the customer to assist in completing the transaction. The recycling module may act as an escrow unit that holds the accepted document until the transaction is completed.

FIG. 1C illustrates a banknote acceptor machine 103 in accordance with various embodiments of the present disclosure. FIG. 1C shows a banknote acceptor machine or banknote feeder machine configured to receive multiple banknotes in bulk to verify the authenticity of the inserted banknotes in bulk. The banknote acceptor machine 103 includes an adapter to accept banknotes in bulk, and has a banknote accepting module, a banknote transport system, and a removable banknote storage unit. Inserted banknotes are separated serially and sent to be authenticated in the banknote accepting module using various sensors. Once the banknote is deemed authentic and deemed acceptable, the banknote is transported further into the banknote acceptor machine 103 using the banknote transport system and into the removable banknote storage unit.

FIG. 1D illustrates a banknote deposit-withdrawal machine 105 in accordance with various embodiments of the present disclosure. In addition to a banknote accepting module or banknote feeder, a banknote transport system, and a removable banknote storage unit as shown in FIG. 1C, the banknote deposit-withdrawal machine 105 illustrated in FIG. 1D comprises a banknote recycling module that allows the unit to provide banknotes back to the customer. For example, the banknote deposit-withdrawal machine 105 could be used in an automated payment system where a customer presents a high denomination banknote to purchase goods or services that are valued more than the value of purchased goods or services and the unit provides lower denomination banknotes to provide change to the customer to assist in completing the transaction. The recycling module may act as an escrow unit that holds the accepted document until the transaction is completed.

Although FIGS. 1A-1D illustrate various examples of payment acceptors and payment deposit-withdrawal machines, various changes may be made to FIGS. 1A-1D. For example, the payment acceptors and payment deposit-withdrawal machines can include coin deposit-withdrawal interfaces and cashless payment interfaces such as credit, debit, or other payment card interfaces, such as a card slot or a near field communication (NFC) antenna for contactless card payments or contactless payment using another device such as a mobile device (e.g., a smartphone using APPLE PAY or GOOGLE PAY). The payment acceptors and payment deposit-withdrawal machines of FIGS. 1A-1D can be used as part of an automated payment system that includes a video bezel such as those described in this disclosure. The payment acceptors and payment deposit-withdrawal machines can be used in automatic ticket seller machines, automatic teller machines, vending machines, self-checkout, cashier assisted checkout, and other point of sale devices, gaming machines, and various other kiosks.

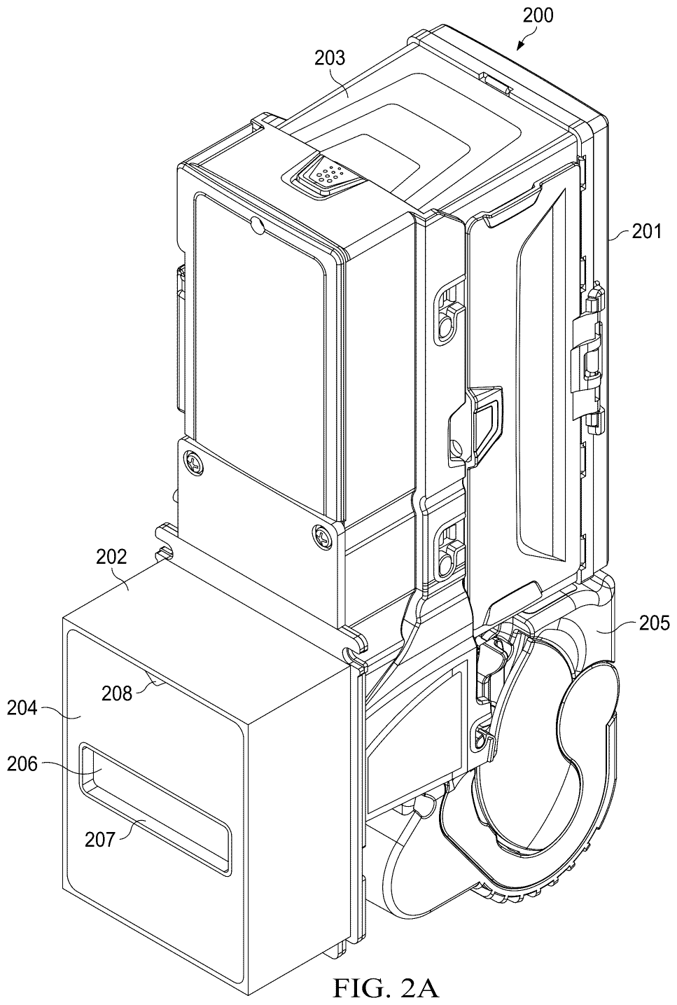

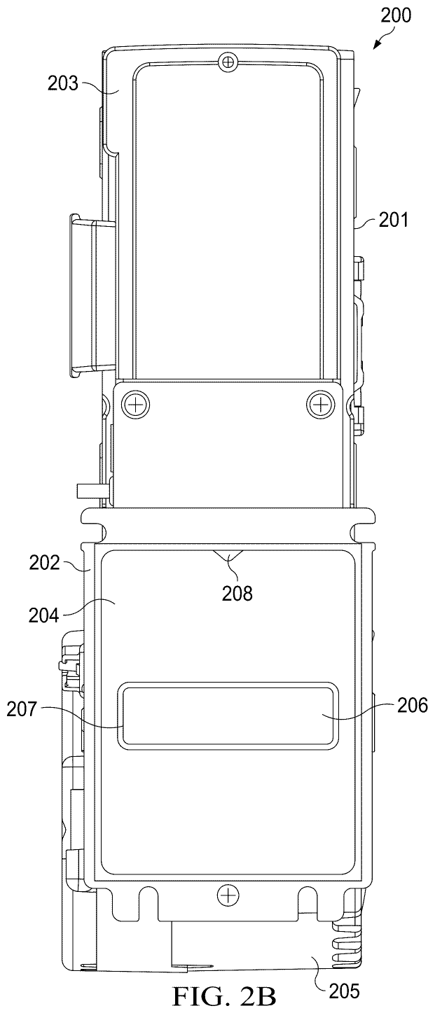

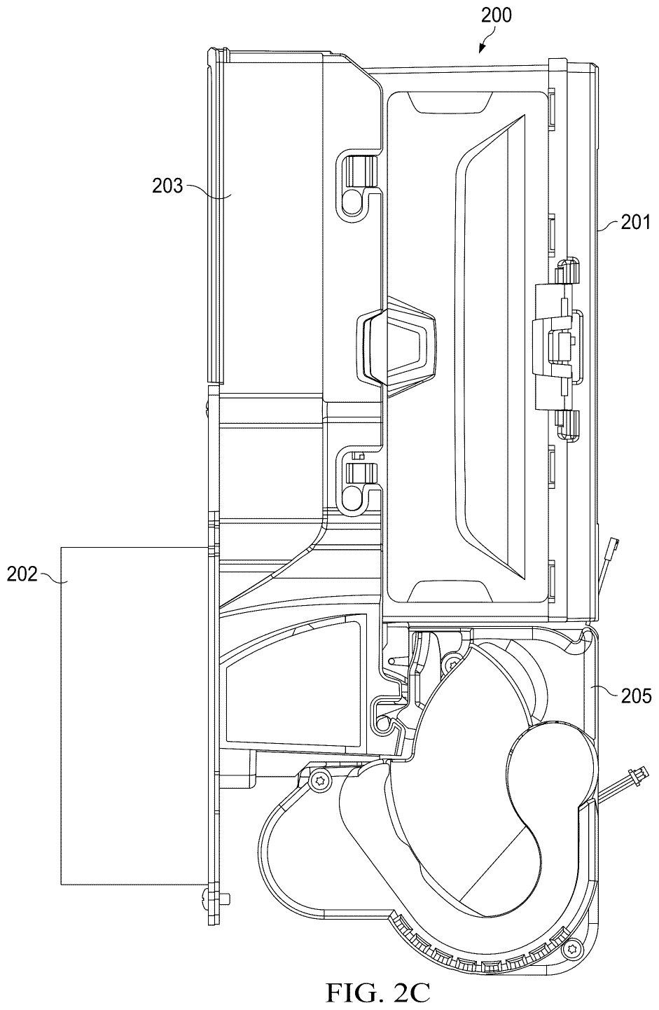

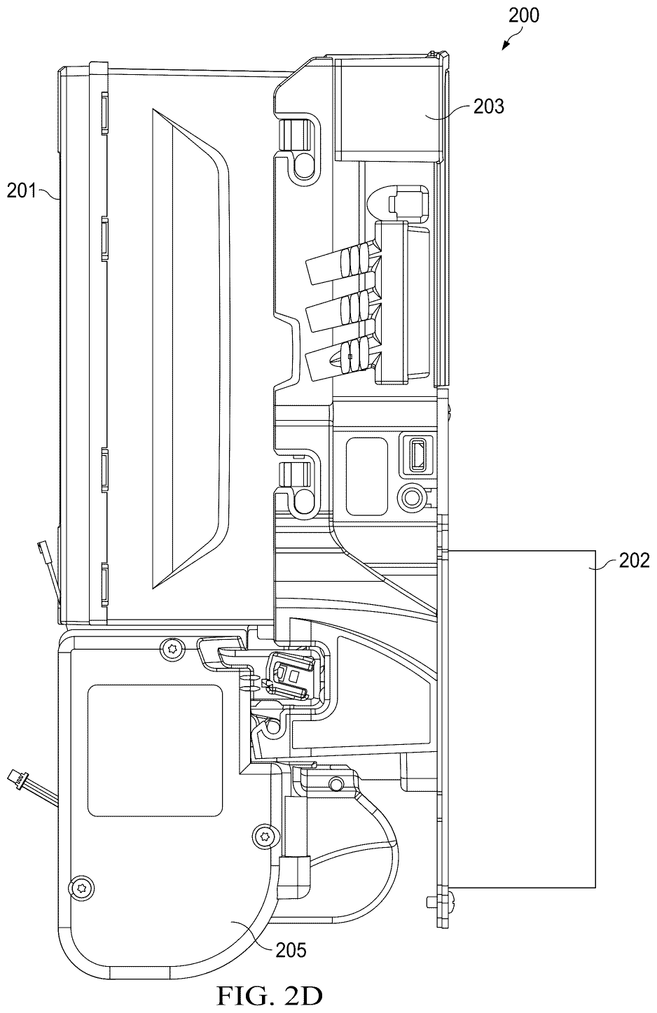

FIGS. 2A-2D illustrate an example automated payment system 200 with a video bezel in accordance with this disclosure. FIG. 2A illustrates a front perspective view of the automated payment system 200. FIG. 2B illustrates a front view of the automated payment system 200. FIG. 2C illustrates a left-side view of the automated payment system 200. FIG. 2D illustrates a right-side view of the automated payment system 200. Automated payment systems come in a wide variety of configurations, and FIGS. 2A-2D do not limit the scope of this disclosure to any particular implementation of an automated payment system. For example, the automated payment system 200 may include any of the payment acceptors or payment withdrawal-deposit machines of FIGS. 1A-1D, incorporating a bezel as described below.

The automated payment system 200 includes a housing or body 201 including an elongated head portion 203 and a lower body portion 205 having various payment accepting devices and interfaces disposed on a front of the lower body portion and covered by a bezel 202. The automated payment system 200 can be installed at a POS location and can include both banknote and coin recyclers. The automated payment system can be installed in, or used as, an automatic ticket seller machine, an automatic teller machine, a vending machine, a self-checkout device, a cashier-assisted checkout device, and other POS devices, gaming machines, and various other kiosks. The bezel 202 includes a display screen 204 covering a front, user-facing, portion of the bezel 202. The display screen can be used for presenting various information and content to users, such as instructional material for use of the automated payment system 200, advertisements, sales or coupons information, entertainment programs information, news, safety notifications, and/or other information or content.

In various embodiments, the display screen 204 can be a liquid crystal display (LCD), such as a light-emitting diode (LED) backlit LCD, a thin-film transistor (TFT) LCD, or a Quantum dot (QLED) display, a light-emitting diode (LED) display, such as an organic light-emitting diode (OLED) display, an active-matrix organic light-emitting diode (AMOLED) display, or a super AMOLED display, or other types of display screens. In some embodiments, the display screen 204 can be a plurality of LEDs, arranged in an array or other suitable arrangement. The LEDs can be controlled as a single group, addressable individually, and/or addressable in groups. In various embodiments, the display screen can be an interactive display screen such as a touch screen. In various embodiments, the display screen can be part of a vending system, such as an Intelligent Vending Display System (IVDS). The payment acceptors and payment deposit-withdrawal machines can be used in automatic ticket seller machines, automatic teller machines, vending machines, self-checkout, cashier assisted checkout, and other point of sale devices, gaming machines, and various other kiosks.

The automated payment system 200 also includes various payment interfaces 206, such as slots or other currency inlets, that a user interacts with as part of a payment receiving process, such as a banknote interface or slot to receive banknotes deposited into the automated payment system 200, a coin deposit interface, such as a hole, slot, or input cup, to receive coins deposited into the automated payment system 200, and/or cashless payment interfaces such as credit, debit, or other payment card interfaces, such as a card slot or a near field communications (NFC) antenna for contactless card payments or mobile device payments. These payment interfaces 206 of the automated payment system 200 can be covered or enclosed by the bezel 202, and, in various embodiments, can be punched through the display screen 204 such that images or video displayed on the display screen 204 wrap around the payment interface. To access the payment interface 206 in order to insert banknotes, coins, or cards, depending on the type of interface, into the automated payment system 200, the display screen 204 includes an aperture 207 punched through the display screen 204 in a location of the display screen 204 corresponding to a location of the interface 206 of the automated payment system 200 that is covered, behind, or enclosed by, the bezel 202.

As also described in the various embodiments of this disclosure, the bezel 202 can also include at least one sensor 208, such as one or more ambient sensors, color or light sensors, infrared sensors, image sensors, and/or cameras for detecting the presence of a user in proximity to the automated payment system 200, detecting lighting conditions of the environment, and/or detecting other information. The sensor 208 can also be punched through the display screen 204, as illustrated in FIGS. 2A-2D. As one non-limiting example, the sensor 208 can include a 3-in-1 color light sensor, proximity sensor, and infrared sensor, such as a TMD3702VC sensor from AMS-OSRAM AG, which is an ambient sensor that provides for a single device integrated optical solution for ambient light sensing (ALS), color sensing, and proximity sensing providing a ±48° field of view, integrated 940 nm IR VCSEL, I2C fast mode compatible interface, power management features and reduced power consumption due to having a 1.8V power supply with a 1.8V I2C bus and a sleep mode, five light sensing channels (RGBC+IR), UV/IR blocking filters, and programmable gain and integration time. The sensor 208 can operate over a wide range of lighting conditions. Based on the optical glass used on top of the sensor 208, custom equations are empirically derived to calculate the amount of ambient light, color temperature, as well as determine the light type, e.g., LED, fluorescent, incandescent, etc., using the ALS results.

In various embodiments of this disclosure, the automated payment system 200 is configured to adjust color temperature, brightness, etc. of the display screen 204 to match the environment based on readings of the sensor 208, allowing the display screen 204 to resemble a picture frame and disappear into the design of the bezel 202 until needed to demand attention. For example, the automated payment system 200 can adjust the color temperature of the display screen 204 to disappear into the design of the rest of the machine such that the display screen 204 appears as “part of the machine.” For example, the display screen 204 may appear like a poster or decal on the machine. So, as the machine appearance changes with the brightness and color of the ambient light, so can the display. The end result is a less jarring, more appealing look. In certain conditions, when needed, such as during a payment process with a user, the display screen 204 can assert itself with max brightness. This can be performed based on a detected presence of a user or based on other factors such as a time of day, in response to new content for display being received by the automated payment system 200, in response to an event such as a breaking news event, or other factors. In various embodiments, the bezel can be removable/detachable from the payment machine. Among various benefits, this allows for the automated payment system to function on its own, and the bezel can be a standalone component that is designed or customized to physically and communicatively couple to the payment machine, and such that its various apertures correspond to the various payment interfaces of the payment machine.

In various embodiments, the sensor 208 can also detect a presence of a user and the intent of the user, such as if the user is intending to use banknotes, coins, or a card during the transaction process. Based on the detected intent, an interface or slot for the intended payment option is illuminated for the user, avoiding slot confusion. In some embodiments, the payment interfaces or slots, such as slot 206, includes transparent or semi-transparent portions that allow for light emitted from at least one light source, such as from LEDs, within an interior portion of the payment interface or slot to be emitted through the transparent or semi-transparent portions. In some embodiments, light source(s) can emit light in various colors, such as green or red, to indicate a status of the automated payment system 200 and/or the payment interfaces. In some embodiments, when the sensor 208 detect the presence of a user, based on a predicted payment intent of the user, a portion of the display screen 204 corresponding one of the one or more payment interfaces can be illuminated using methods available to various types of display screens. In some embodiments, the bezel 202 can also include transparent or semi-transparent portions and can also include a design indicating to the user that the automated payment system is capable of cashless and contactless payments, or such a design can be displayed on the display screen 204 in a location of the automated payment system 200 associated with the cashless and contactless payment option, such as near a location of an NFC antenna. The NFC antenna, in some embodiments, can be installed behind the bezel 202, or in other locations, such as in a location of the automated payment system 200 above the bezel 202. It will be understood that the automated payment system 200 and the bezel 202 can be modified without departing from the scope of this disclosure, such as changing shapes, dimensions, orientations, or component placements, or making other modifications, to the design illustrated in FIGS. 2A-2D.

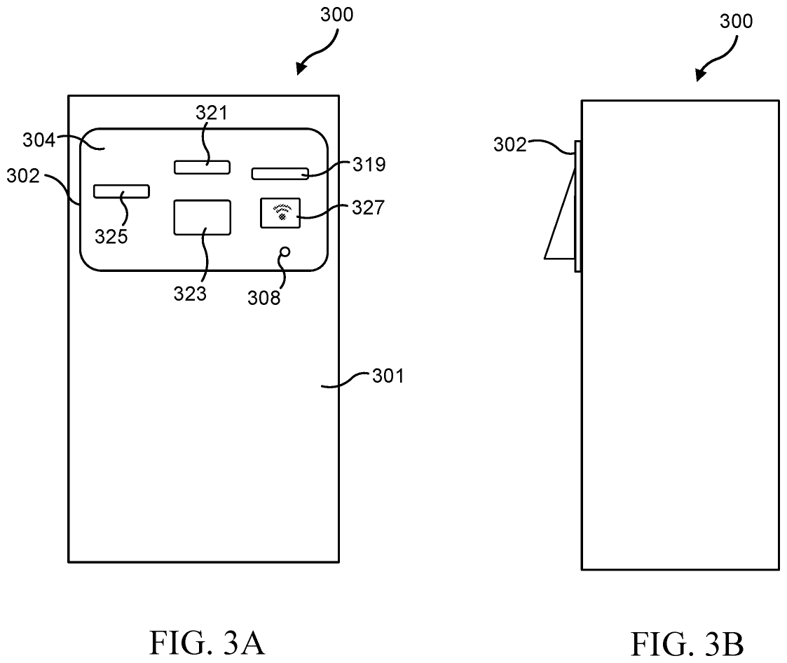

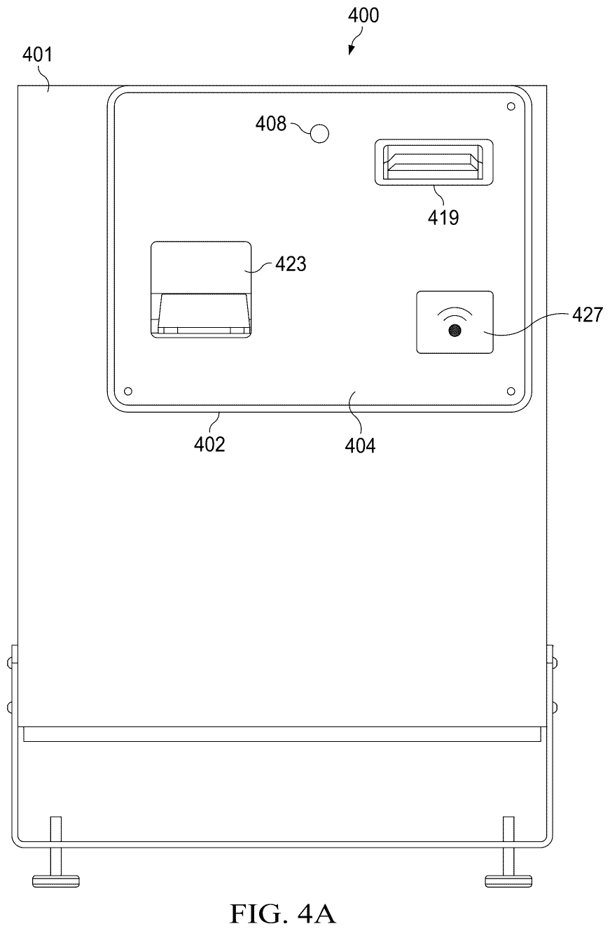

FIGS. 3A and 3B illustrate another example automated payment system 300 with a video bezel 302 in accordance with this disclosure. The automated payment system 300 includes a body or housing 301 that contains each of a banknote machine, a card reader, and a coin machine.

The video bezel 302 includes a display screen 304. The video bezel 302 includes a banknote slot 319, a coin deposit slot 321, a coin dispensing slot 323, and a card slot 325, each having an associated aperture punched through the screen. The video bezel 302 can also include a contactless payment interface 327, such as an NFC interface, that allows for tapping a card or mobile device to perform a transaction. In some embodiments, the contactless payment interface 327 may not require a punch through as the hardware for the NFC interface may be installed within or behind the video bezel 302, and the wireless signal can be received by the contactless payment interface 327 through the screen, with the display screen 304 displaying a tap area for the contactless payment interface 327. The banknote interface or slot 319 can be to a banknote machine such as described and shown with respect to FIGS. 2A-2D, the coin interfaces or slots 321, 323 can be to a coin machine, and the card interface or slot can be to a card machine. The bezel 302 can also have at least one sensor 308, such as an ALS, punched through the screen 304, such as also described with respect to FIGS. 2A-2D.

In various embodiments, the bezel can be removable/detachable from the payment machine. Among various benefits, this allows for the automated payment system to function on its own, and the bezel can be a standalone component that is designed or customized to physically and communicatively couple to the payment machine, and such that its various apertures correspond to the various payment interfaces of the payment machine.

It will be understood that the bezel 302 of the automated payment system 300 can include many of the same features of the bezel 202 described with respect to FIGS. 2A-2D, such as the 3-in-1 color light sensor for ambient light sensing, color sensing, and user proximity sensing, including the ability to adjust the color temperature and/or the brightness of the screen 304 based on environmental conditions such as lighting, user proximity, an ongoing transaction, etc., transparent or semi-transparent portions of the slots 319, 321, 323, 325 to allow for the slots, and/or other payment interfaces, to be illuminated, etc. It will be understood that the automated payment system 300 and the bezel 302 can be modified without departing from the scope of this disclosure, such as changing shapes, dimensions, orientations, or component placements, or making other modifications. For example, it will be understood that various machines, or a single machine including banknote, coin, and card processing components, can be included within the housing, and, depending on the arrangement or configuration of the various machines or the single machine, the arrangement of the interfaces or slots of the video bezel. In the example of FIGS. 3A and 3B, the coin interfaces or slots 321, 323 are arranged in a center area of the screen 304, and the banknote interface or slot 319 is arranged on a right side area of the screen 304. But, for example, the coin interfaces or slots could be arranged in a right side area of a screen of the bezel, and a banknote interface or slot could be arranged in a center area of the screen.

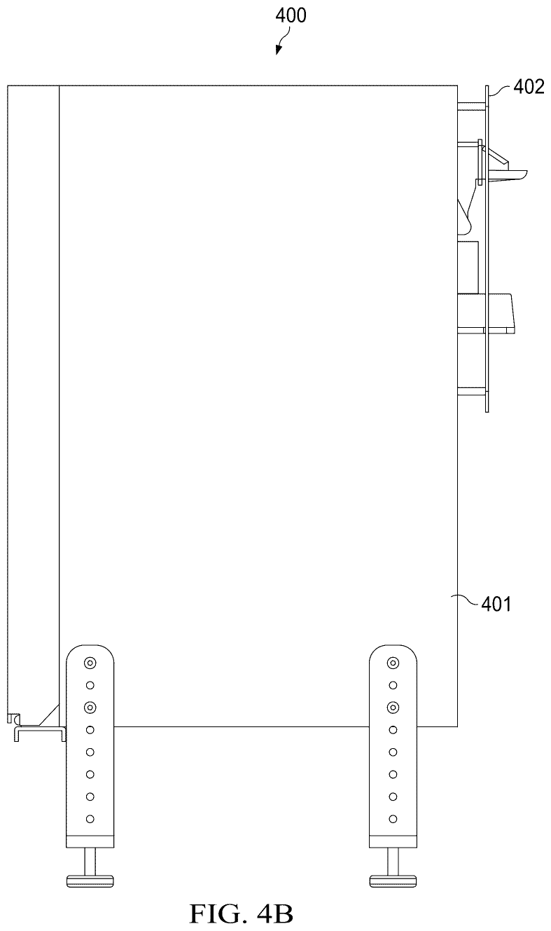

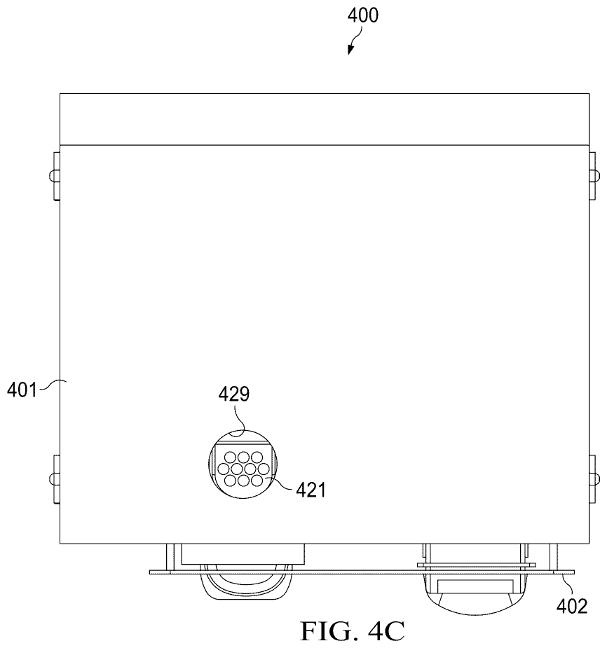

FIGS. 4A, 4B, and 4C illustrate another example automated payment system 400 with a video bezel 402 in accordance with this disclosure. The automated payment system 400 includes a body or housing 401 of a payment machine with the video bezel 402 on a front surface of the housing 401. The video bezel 402 includes a coin dispensing slot 423 and a banknote slot 419 punched through a screen 404 of the video bezel 402, as well as at least one sensor 408 punched through the screen 404, such as an ALS. The automated payment system 400 also includes a coin deposit interface 421 through an aperture 429 on a top portion of the housing 401. The automated payment system 400 can also include a contactless payment interface 427, such as an NFC interface, that allows for tapping a card or mobile device to perform a transaction. In some embodiments, the contactless payment interface 427 may not require a punch through as the hardware for the NFC interface may be installed within or behind the video bezel 402, and the wireless signal can be received by the contactless payment interface 427 through the screen, with the display screen 404 displaying a tap area for the contactless payment interface 427. This example automated payment system 400 is free standing, with one or more legs, and includes a handle that opens and closes a door on a back side of the housing 401 that allows an operator easy access to the payment machine(s) housed within the housing 401.

It will be understood that the bezel 402 of the automated payment system 400 can include many of the same features of the bezel 202 described with respect to FIGS. 2A-2D, such as the 3-in-1 color light sensor for ambient light sensing, color sensing, and user proximity sensing, including the ability to adjust the color temperature and/or the brightness of the screen 404 based on environmental conditions such as lighting, user proximity, an ongoing transaction, etc., transparent or semi-transparent portions of the slots 419, 421, 423 to allow for the slots, and/or other payment interfaces, to be illuminated, etc. In various embodiments, the bezel can be removable/detachable from the payment machine. Among various benefits, this allows for the automated payment system to function on its own, and the bezel can be a standalone component that is designed or customized to physically and communicatively couple to the payment machine, and such that its various apertures correspond to the various payment interfaces of the payment machine. It will be understood that the automated payment system 400 and the bezel 402 can be modified without departing from the scope of this disclosure, such as changing shapes, dimensions, orientations, or component placements, or making other modifications.

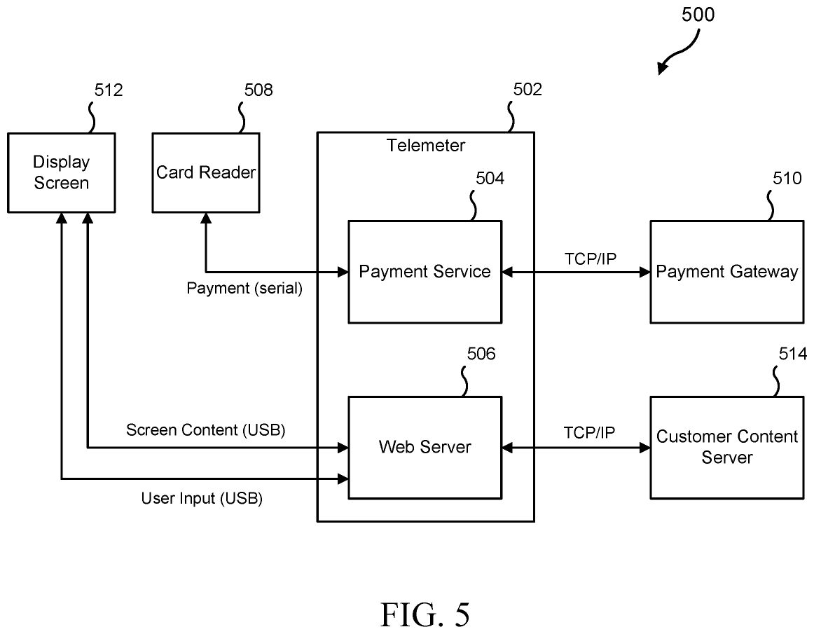

FIG. 5 illustrates an example communications system 500 of an automated payment system in accordance with this disclosure. The example communications system 500 can be used with any of the automated payment systems or devices described in this disclosure. The communications system 500 includes a telemeter 502 including a payment service 504 and a web server 506. The payment service 504 is connected, such a via a serial connection, to a card reader 508. The payment service 504 is further communicatively connected to a payment gateway 510, such as via a TCP/IP connection. The web server 506 is connected, such as via USB, to a display screen 512. The display screen 512 can be a part of an automated payment system or device, such as the display screen 204 or any of the other display screens of this disclosure. The card reader 508 can be installed within or near the automated payment system or device.

The web server 506 provides content for presentation on the display screen 512, such as instructional material for use of the payment acceptors and payment deposit-withdrawal systems, advertisements, sales or coupons, entertainment programs, news, and/or safety notifications, and can also receive information from the display screen 512 or another component of the automated payment system or device, such as user inputs. The web server 506 communicates with a customer content server 514 to receive content for display on the display screen 512, such as over a TCP/IP connection. In this way, content can be provided for display on the display screen 512 for users to view as they pass by the display screen 512, or while using the display screen 512, such as during a transaction using the automated payment system or device.

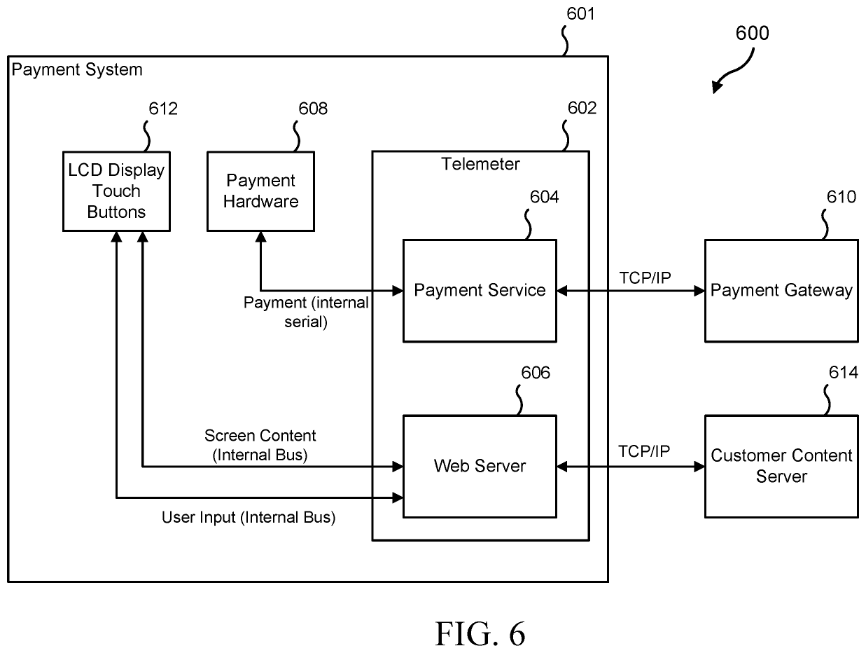

FIG. 6 illustrates an example communications system 600 of an automated payment system in accordance with this disclosure. The system 600 includes a telemeter, including a payment service and a web server, within a same housing as a display screen, such as display screen 204, and user interface, which can include touch buttons, as well as the housing including UIC hardware. The UIC hardware is connected to the payment service is connected, such a via an internal serial connection. The payment service is further communicatively connected to a payment gateway, such as via a TCP/IP connection. The web server is connected, such as via an internal bus, to the display screen and user interface. The web server provides content for the screen, such as instructional material for use of the payment acceptors and payment deposit-withdrawal systems, advertisements, sales or coupons, entertainment programs, news, and/or safety notifications, and can also receive information from the screen such as user inputs. The web server communicates with a customer content server to receive content for display on the screen, such as over a TCP/IP connection.

The example communications system 600 can be used with any of the automated payment systems or devices described in this disclosure. The communications system 600 includes a telemeter 602, including a payment service 604 and a web server 606, within a same housing 601 of an automated payment system as a display screen 612. The display screen 612 can be the display screen 204 or any of the other display screens of this disclosure. In some embodiments, the display screen 612 can include a user interface, which can include touchscreen buttons. The housing 601 also includes payment hardware 608, e.g., a card reader or other payment solutions. The payment hardware 608, in this example, is communicatively connected to the payment service 604 via an internal serial connection. The payment service 604 is further communicatively connected to a payment gateway 610, such as via a TCP/IP connection. The web server 606 is connected, such as via at least one internal bus connection, to the user interface and the display screen 612.

The web server 606 provides content for presentation on the display screen 612, such as instructional material for use of the payment acceptors and payment deposit-withdrawal systems, advertisements, sales or coupons, entertainment programs, news, and/or safety notifications, and can also receive information from the display screen 612 or another component of the automated payment system or device, such as user inputs. The web server 606 communicates with a customer content server 614 to receive content for display on the display screen 612, such as over a TCP/IP connection. In this way, content can be provided for display on the display screen 612 for users to view as they pass by the display screen 612, or while using the display screen 612, such as during a transaction using the automated payment system or device.

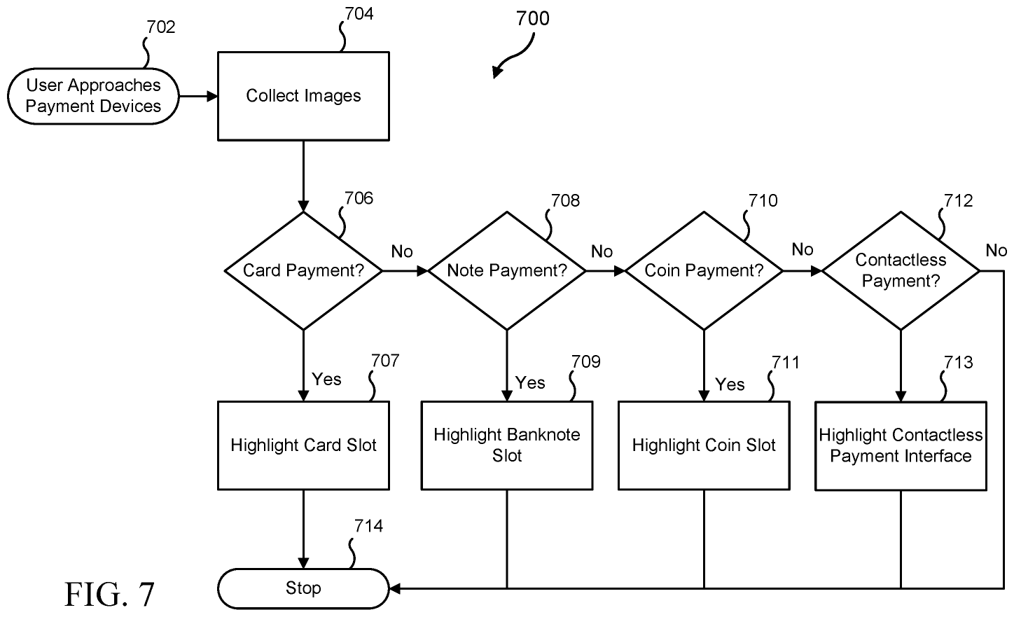

FIG. 7 illustrates a customer intent and payment interface accentuation process 700 in accordance with this disclosure. A common issue with current payment systems is that customers can become confused as to what slot to use for which payment. For example, since banknote slots often look like card slots, people erroneously put coins in banknote slots, etc. The automated payment systems of the various embodiments of this disclosure, using one or more sensors such as a proximity and/or image sensor, such as sensor 208, can detect the presence of a user, detect user intent, and highlight the correct slot based on the detected user intent.

For example, as illustrated in FIG. 7, the process 700 includes, at step 702, a user approaching payment devices of an automated payment system. At step 704, the sensor(s) detect the presence of the user and collects images of the user. Based on the images, the automated payment system, such as via at least one processor of the automated payment system executing an application from internal memory, predicts the user's intent, such as by detecting in the images that the user is handling banknotes, coins, or a card. In some embodiments, the processor may be in the housing of the payment machine and communicating with the sensors and the display screen of the bezel. In some embodiments, at least a portion of the processing may be performed by a processor in the bezel itself, such as in embodiments in which the bezel is a removable/detachable device. For example, at step 706, if the processor determines the user is handling a card, at step 707 the processor causes a signal to be sent to highlight or illuminate a card payment interface or slot, or an area of the display corresponding to the banknote payment interface in some embodiments, and/or a contactless (e.g., an NFC) payment interface or area of the display screen. Similarly, if, at step 708, the processor determines from the images that the user intends to use banknotes, at step 709 the processor causes a signal to be sent to highlight or illuminate a banknote payment interface or slot, or an area of the display corresponding to the banknote payment interface in some embodiments. If, at step 710, the processor determines from the images that the user intends to use coins, at step 711 the processor causes a signal to be sent to highlight or illuminate a coin payment interface or slot, or an area of the display corresponding to the coin payment interface in some embodiments. If, at step 712, the processor determines from the images that the user intends to use a contactless payment method, such as if the user is handling a card or a mobile device, at step 713 the processor causes a signal to be sent to highlight or illuminate the contactless payment interface or area of the display screen. The process then ends at step 714.

Although FIG. 7 illustrates one example customer intent and payment interface accentuation process 700, various changes may be made to FIG. 7. For example, while shown as a series of steps, various steps in FIG. 7 could overlap, occur in parallel, occur in a different order, or occur any number of times. As a particular example, in some embodiments, the automated payment system can perform a combination of steps 706-711. For instance, the automated payment system may detect that the user is handles more than one payment type during a transaction, such as both banknotes and coins, whereby the processor causes a signal to be sent to highlight the banknote slot while the user is attempting to insert banknotes, and then, during the same interaction with the user, causes a signal to be sent to highlight the coin slot in the event the user switches to inserting coins.

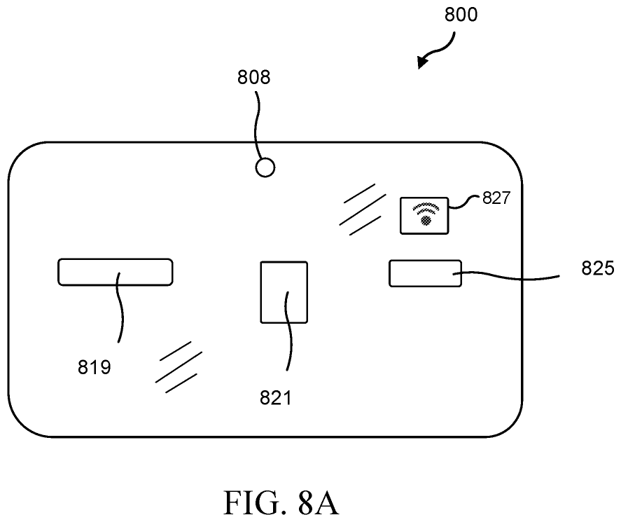

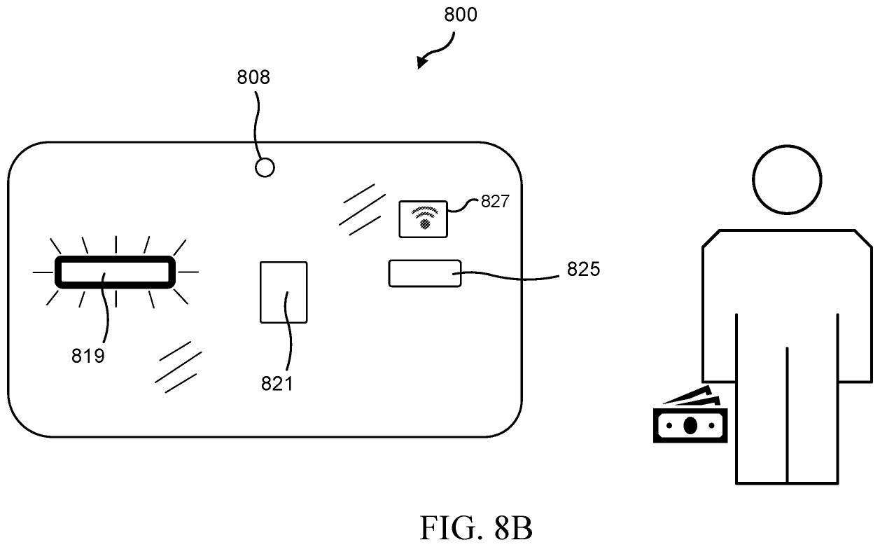

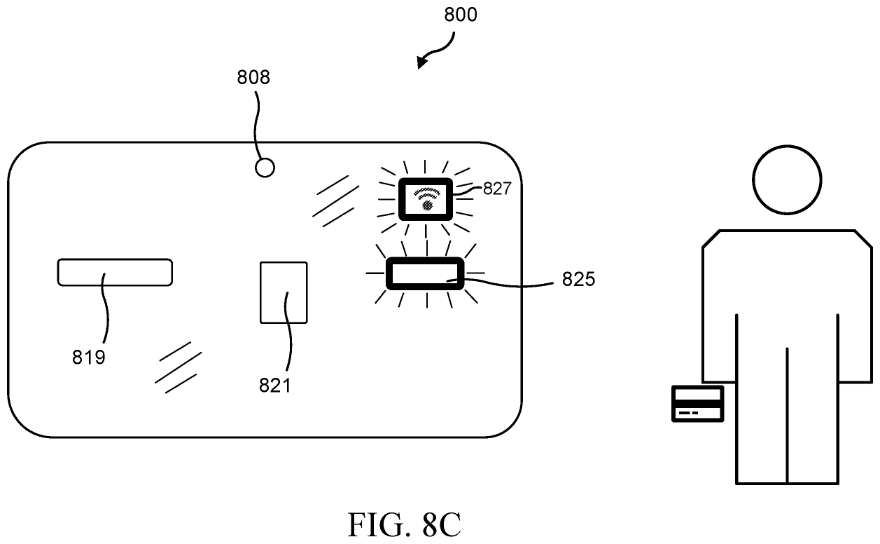

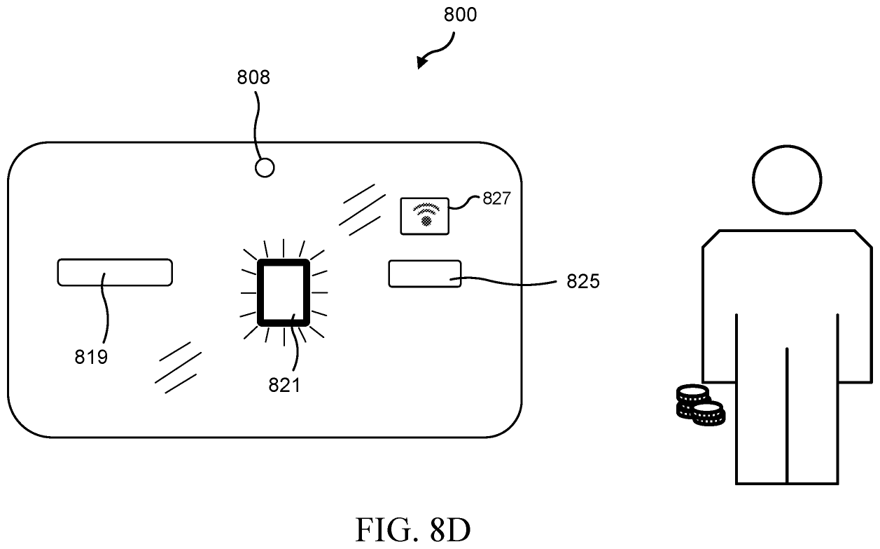

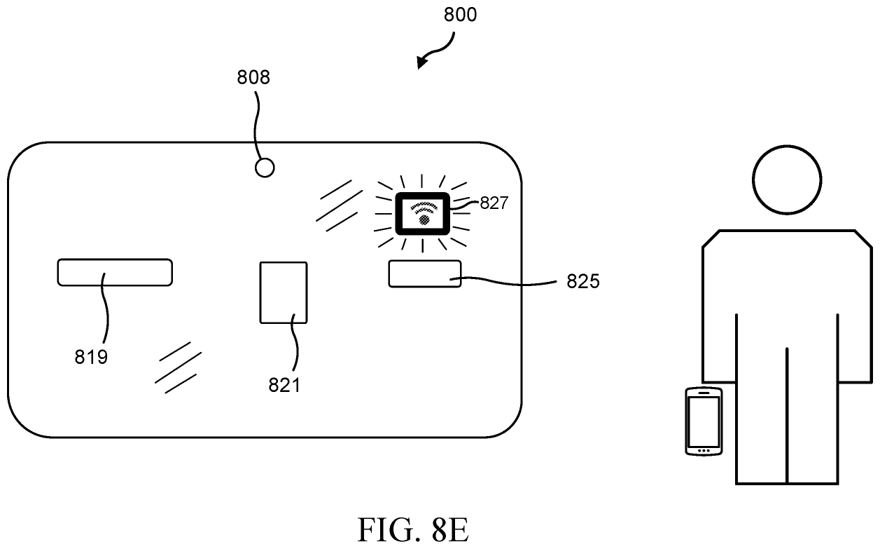

For example, FIGS. 8A-8E illustrate a display screen 800 in accordance with this disclosure. In various embodiments, the display screen 800 can be the display screen 204, 404, or any of the other display screens of the various automated payment system of this disclosure. As illustrated in FIG. 8A, the display screen 800 includes at least one sensor 808, such as the sensor 208, which can be an imaging sensor, a camera, and/or the 3-in-1 sensor described in this disclosure. The display screen 800 can display content wrapping around multiple payment interfaces or slots, including a banknote interface 819, a coin interface 821, a card interface 825, and a contactless payment interface 827, such as an NFC interface, operable for banknote entry, coin entry, card entry, and contactless payment, respectively. In some embodiments, the card interface 825 and the contactless payment interface 827 can be included in a same interface.

For example, as illustrated in FIG. 8B, the sensor 808 is used to detect a user with one or more banknotes approaching, and thus is used by the automated payment system to determine the user's intent to provide one or more banknotes for the transaction. In response, the banknote interface 819 is illuminated to indicate to the user which slot to use for inputting banknotes. As illustrated in FIG. 8C, the sensor 808 is used to detect a user with a card approaching, and thus is used by the automated payment system to determine the user's intent to provide a card for the transaction. In response, the card interface 821 is illuminated to indicate to the user which slot to use for inputting a payment card. In some embodiments, the contactless payment interface 827 can also be illuminated to indicate to the user the area for tapping the card to perform a contactless payment transaction. As illustrated in FIG. 8D, the sensor 808 is used to detect a user with one or more coins approaching, and thus is used by the automated payment system to determine the user's intent to provide one or more coins for the transaction. In response, the coin interface 821 is illuminated to indicate to the user which slot to use for inputting coins. In some embodiments, a separate coin dispensing slot can also be illuminated to show the user where coins are dispensed. As illustrated in FIG. 8E, the sensor 808 is used to detect a user with a contactless payment device (e.g., a smartphone) approaching, and thus is used by the automated payment system to determine the user's intent to possibly provide contactless payment. In response, the contactless payment interface 827 is illuminated to indicate to the user the area for tapping the contactless payment device to perform a contactless payment transaction.

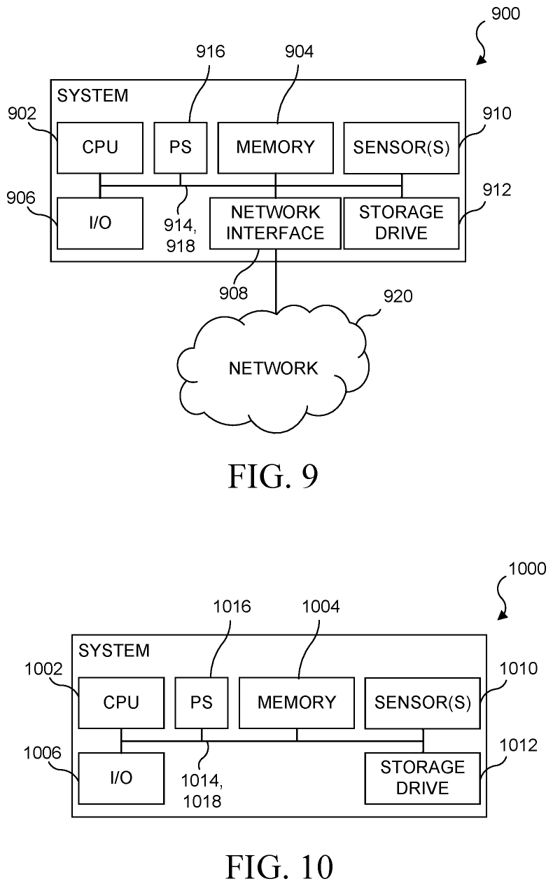

FIG. 9 illustrates an example electronic device 900 in accordance with this disclosure. The device 900 can be one example of a portion of an automated payment system, such as automated payment system 200, or of other systems such as a banknote or coin recycler, a point-of-sale terminal, or other devices. The system 900 can include a controller (e.g., a processor/central processing unit (“CPU”)) 902, a memory unit 904, and an input/output (“I/O”) device 906. The device 900 also includes at least one network interface 908, or network interface controllers (NICs).

The device 900 further includes at least sensor 910 for capturing media or inputs to the system through an I/O device, such as imaging sensor(s), an NFC sensor(s), etc. In some embodiments, the capture device is not included. The device 900 also includes a storage drive 912 used for storing content such as PIN inputs. The components 902, 904, 906, 908, 910, and 912 are interconnected by a data transport system (e.g., a bus) 914. A power supply unit (PSU) 916 provides power to components of the system 900 via a power transport system 918 (shown with data transport system 914, although the power and data transport systems may be separate).

It is understood that the system 900 may be differently configured and that each of the listed components may actually represent several different components. For example, the CPU 902 may actually represent a multi-processor or a distributed processing system; the memory unit 904 may include different levels of cache memory, and main memory; the I/O device 906 may include monitors, keyboards, payment interfaces such as those described herein, display screens or touchscreens, such as display screens 204, 800, and the like; the at least one network interface 908 may include one or more network cards providing one or more wired and/or wireless connections to a network 920; and the storage drive 912 may include hard disks and remote storage locations. Therefore, a wide range of flexibility is anticipated in the configuration of the system 900, which may range from a single physical platform configured primarily for a single user or autonomous operation to a distributed multi-user platform such as a cloud computing system.

The system 900 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the system 900. In some embodiments, the system 900 can be a compact system such as a Raspberry Pi running a Linux-based operating system such as Debian. The operating system, as well as other instructions (e.g., for telecommunications and/or other functions provided by the device 900), may be stored in the memory unit 904 and executed by the processor 902. For example, if the system 900 is, or is part of, the automated payment system 200, the memory unit 904 may include instructions for performing some or all of the steps, process, and methods described herein.

The network 920 may be a single network or may represent multiple networks, including networks of different types, whether wireless or wired. For example, the device 900 may be coupled to external devices via a network that includes a cellular link coupled to a data packet network or may be coupled via a data packet link such as a wide local area network (WLAN) coupled to a data packet network or a Public Switched Telephone Network (PSTN). Accordingly, many different network types and configurations may be used to couple the device 900 with external devices.

FIG. 10 illustrates an example electronic device 1000 in accordance with this disclosure. The device 1000 can be one example of a portion of an automated payment system, such as automated payment system 200, or of other systems such as a banknote or coin recycler, a point-of-sale terminal, or other devices. The system 1000 includes a controller (e.g., a processor/central processing unit (“CPU”)) 1002, a memory unit 1004, and an I/O device 1006. The device 1000 further includes at least one sensor 1010 for capturing media or inputs to the system through an I/O device, such as an imaging sensor(s), an NFC sensor(s), etc. In some embodiments, the capture device is not included. The device 1000 also includes a storage drive 1012 used for storing content such as PIN inputs. The components 1002, 1004, 1006, 1010, and 1012 are interconnected by a data transport system (e.g., a bus) 1014. A PSU 1016 provides power to components of the system 1000 via a power transport system 1018 (shown with data transport system 1014, although the power and data transport systems may be separate).

It is understood that the system 1000 may be differently configured and that each of the listed components may actually represent several different components. For example, the CPU 1002 may actually represent a multi-processor or a distributed processing system; the memory unit 1004 may include different levels of cache memory, and main memory; the I/O device 1006 may include monitors, keyboards, payment interfaces such as those described herein, display screens or touchscreens, such as display screens 204, 800, and the like; and the storage drive 1012 may include hard disks and remote storage locations. Therefore, a wide range of flexibility is anticipated in the configuration of the system 1000, which may range from a single physical platform configured primarily for a single user or autonomous operation to a distributed multi-user platform such as a cloud computing system.

The system 1000 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the system 1000. In some embodiments, the system 1000 can be a compact system such as a Raspberry Pi running a Linux-based operating system such as Debian. The operating system, as well as other instructions (e.g., for telecommunications and/or other functions provided by the device 1000), may be stored in the memory unit 1004 and executed by the processor 1002. For example, if the system 1000 is, or is part of, the automated payment system 200, the memory unit 1004 may include instructions for performing some or all of the steps, process, and methods described herein.

In one example embodiment, an automated payment system comprises a housing, one or more payment interfaces, a bezel disposed on a user-facing side of the housing, and a display screen coupled to the bezel, the display screen including one or more apertures each formed through a portion of the display screen, wherein each of the one or more apertures corresponds to one of the one or more payment interfaces.

In one or more of the above examples, the automated payment system further comprises at least one processor and at least one sensor.

In one or more of the above examples, the at least one sensor is disposed through another aperture formed through another portion of the display screen.

In one or more of the above examples, the at least one sensor is configured to detect ambient lighting conditions of an environment external to the housing, wherein, based on the detected ambient lighting conditions, the at least one processor adjusts at least one of a color temperature and a brightness of the display screen.

In one or more of the above examples, the at least one sensor is configured to detect a presence of a user, and wherein the at least one processor adjusts at least one of the color temperature, the brightness, and a content of the display screen based on the detected presence of the user.

In one or more of the above examples, the at least one sensor is configured to capture at least one image of a user, and wherein, based on a predicted payment intent of the user, the at least one processor causes transmission of a signal to illuminate a light source corresponding to one of the one or more payment interfaces.

In or more of the above examples, the at least one sensor is configured to capture at least one image of a user, and wherein, based on a predicted payment intent of the user, the at least one processor causes transmission of a signal to illuminate a portion of the display screen corresponding to one of the one or more payment interfaces.

In one or more of the above examples, the one or more payment interfaces include one or more of a banknote payment interface, a coin payment interface, a card payment interface, and

In one or more of the above examples, the predicted payment intent includes a prediction, based on the at least one image of the user by the at least one sensor, of a payment type intended for use by the user in a transaction using the automated payment system.

In one or more of the above examples, the automated payment system includes a chute or conveyor connected to the coin payment interface and operable to transport coins from the coin payment interface to a coin processing device.

In one or more of the above examples, the sensor is disposed through another aperture formed through a portion of the display screen.

In one or more of the above examples, the display screen is configured to display a plurality of images.

In one or more of the above examples, the at least one processor is further configured to cause the automated payment system to receive content including the plurality of images from one or more servers.

In one or more of the above examples, the plurality of images is displayed such that the plurality of images wraps around the one or more apertures.

In another example embodiment, a method comprises detecting, by at least one sensor of an automated payment system, a presence of a user, wherein the automated payment system includes a display screen coupled to a bezel, capturing, by the at least one sensor, at least one image of the user, predicting, by at least one processor of the automated payment system, a payment intent of the user, and causing, by the at least one processor, transmission of a signal to illuminate one of one or more payment interfaces disposed adjacent to corresponding apertures formed through the display screen.

In one or more of the above examples, causing the transmission of the signal to illuminate the one of the one or more payment interfaces causes illumination of a light source corresponding to the one of the one or more payment interfaces.

In one or more of the above examples, causing the transmission of the signal to illuminate the one of the one or more payment interfaces causes illumination of a portion of the display screen corresponding to one of the one or more payment interfaces.

In one or more of the above examples, the method further comprises adjusting, by at least one processor of the automated payment system, based on the detected presence of the user, at least one of a color temperature, a brightness, and a content of the display screen.

In one or more of the above examples, the sensor is disposed through another aperture formed through a portion of the display screen.

In one or more of the above examples, the method further comprises receiving, at the automated payment system from one or more servers, content including a plurality of images and displaying, on the display screen, at least one of the plurality of images.

In one or more of the above examples, the plurality of images is displayed such that the plurality of images wraps around the apertures.

In one or more of the above examples, the method further comprises detecting, using the at least one sensor, ambient lighting conditions of an environment external to a housing of the automated payment system and, based on the detected ambient lighting conditions, adjusting, by the at least one processor, at least one of a color temperature and a brightness of the display screen.

In one or more of the above examples, the one or more payment interfaces include one or more of a banknote payment interface, a coin payment interface, a card payment interface, and

In one or more of the above examples, the method further comprises transporting one or more coins received via the coin payment interface to a coin processing device using a chute or conveyor of the automated payment system connected to the coin payment interface.

In one or more of the above examples, the predicted payment intent includes a prediction, based on the at least one image of the user by the at least one sensor, of a payment type intended for use by the user in a transaction using the automated payment system.

In another example embodiment an apparatus includes a bezel operable to attach to a user-facing side of a housing of a payment machine, at least one sensor configured to detect environmental conditions external to the housing of the payment machine, and a display screen coupled to the bezel, the display screen including one or more apertures each formed through a portion of the display screen, wherein each of the one or more apertures corresponds to a payment interface of the payment machine.

In one or more of the above examples, the bezel is removably attached to the housing.

In one or more of the above examples, the apparatus further comprises an NFC antenna disposed behind the display screen for performing contactless payments.

In one or more of the above examples, the apparatus further comprises at least one processor, wherein, based on the detected environmental conditions including a detection of an ambient lighting, the at least one processor adjusts at least one of a color temperature and a brightness of the display screen.

In one or more of the above examples, the apparatus further comprises at least one processor, wherein, based on the detected environmental conditions including a detection of a presence of a user, the at least one processor adjusts at least one of a color temperature, a brightness, and a content of the display screen.

In one or more of the above examples, the apparatus further comprises at least one processor, wherein the at least one sensor is configured to capture at least one image of a user, and wherein, based on a predicted payment intent of the user, the at least one processor causes transmission of a signal to illuminate a light source corresponding to the payment interface.

In one or more of the above examples, the apparatus further comprises at least one processor, wherein the at least one sensor is configured to capture at least one image of a user, and wherein, based on a predicted payment intent of the user, the at least one processor causes transmission of a signal to illuminate a portion of the display screen corresponding to one of the one or more payment interfaces.

In one or more of the above examples, the predicted payment intent includes a prediction, based on the at least one image of the user by the at least one sensor, of a payment type intended for use by the user in a transaction using the payment machine.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

The present disclosure should not be read as implying that any particular element, step, or function is an essential element, step, or function that must be included in the scope of the claims. Moreover, the claims are not intended to invoke 35 U.S.C. § 112(f) unless the exact words “means for” are followed by a participle.

1. An automated payment system, comprising:
a housing;
one or more payment interfaces;
a bezel disposed on a user-facing side of the housing; and
a display screen coupled to the bezel, the display screen including one or more apertures each formed through a portion of the display screen, wherein each of the one or more apertures corresponds to one of the one or more payment interfaces.

2. The automated payment system of claim 1, further comprising:
at least one processor; and
at least one sensor, wherein the at least one sensor is disposed through another aperture formed through another portion of the display screen.

3. The automated payment system of claim 2, wherein the at least one sensor is configured to detect ambient lighting conditions of an environment external to the housing,
wherein, based on the detected ambient lighting conditions, the at least one processor adjusts at least one of a color temperature and a brightness of the display screen.

4. The automated payment system of claim 3, wherein the at least one sensor is configured to detect a presence of a user, and wherein the at least one processor adjusts at least one of the color temperature the brightness, and a content of the display screen based on the detected presence of the user.

5. The automated payment system of claim 2, wherein the at least one sensor is configured to capture at least one image of a user, and wherein, based on a predicted payment intent of the user, the at least one processor causes transmission of a signal to illuminate a light source corresponding to one of the one or more payment interfaces.

6. The automated payment system of claim 2, wherein the at least one sensor is configured to capture at least one image of a user, and wherein, based on a predicted payment intent of the user, the at least one processor causes transmission of a signal to illuminate a portion of the display screen corresponding to one of the one or more payment interfaces.

7. (canceled)

8. The automated payment system of claim 6, wherein the predicted payment intent includes a prediction, based on the at least one image of the user by the at least one sensor, of a payment type intended for use by the user in a transaction using the automated payment system.

9. The automated payment system of claim 2, wherein the at least one processor is further configured to cause the automated payment system to receive content including a plurality of images from one or more servers, wherein the display screen is configured to display the plurality of images.

10. A method comprising:
detecting, by at least one sensor of an automated payment system, a presence of a user, wherein the automated payment system includes a display screen coupled to a bezel;
capturing, by the at least one sensor, at least one image of the user;
predicting, by at least one processor of the automated payment system, a payment intent of the user; and
causing, by the at least one processor, transmission of a signal to illuminate one of one or more payment interfaces disposed adjacent to corresponding apertures formed through the display screen.

11. The method of claim 10, wherein causing the transmission of the signal to illuminate the one of the one or more payment interfaces causes illumination of a light source corresponding to the one of the one or more payment interfaces.

12. The method of claim 10, wherein causing the transmission of the signal to illuminate the one of the one or more payment interfaces causes illumination of a portion of the display screen corresponding to one of the one or more payment interfaces.

13. The method of claim 10, further comprising adjusting, by the at least one processor of the automated payment system, based on the detected presence of the user, at least one of a color temperature, a brightness, and a content of the display screen.

14. (canceled)

15. The method of claim 10, further comprising:
receiving, at the automated payment system from one or more servers, content including a plurality of images; and
displaying, on the display screen, at least one of the plurality of images.

16. The method of claim 10, further comprising:
detecting, using the at least one sensor, ambient lighting conditions of an environment external to a housing of the automated payment system; and
based on the detected ambient lighting conditions, adjusting, by the at least one processor, at least one of a color temperature and a brightness of the display screen.

17. (canceled)

18. The method of claim 10, wherein the predicted payment intent includes a prediction, based on the at least one image of the user by the at least one sensor, of a payment type intended for use by the user in a transaction using the automated payment system.

19. An apparatus comprising:
a bezel operable to attach to a user-facing side of a housing of a payment machine;
at least one sensor configured to detect environmental conditions external to the housing of the payment machine; and
a display screen coupled to the bezel, the display screen including one or more apertures each formed through a portion of the display screen, wherein each of the one or more apertures corresponds to a payment interface of the payment machine.

20. (canceled)

21. (canceled)

22. The apparatus of claim 19, further comprising at least one processor, wherein, based on the detected environmental conditions including a detection of an ambient lighting, the at least one processor adjusts at least one of a color temperature and a brightness of the display screen.

23. The apparatus of claim 19, further comprising at least one processor, wherein, based on the detected environmental conditions including a detection of a presence of a user, the at least one processor adjusts at least one of a color temperature, a brightness, and content of the display screen.

24. The apparatus of claim 19, further comprising at least one processor, wherein the at least one sensor is configured to capture at least one image of a user, and wherein, based on a predicted payment intent of the user, the at least one processor causes transmission of a signal to illuminate a light source corresponding to the payment interface.

25. The apparatus of claim 19, further comprising at least one processor, wherein the at least one sensor is configured to capture at least one image of a user, and wherein, based on a predicted payment intent of the user, the at least one processor causes transmission of a signal to illuminate a portion of the display screen corresponding to one of the one or more payment interfaces,
wherein the predicted payment intent includes a prediction, based on the at least one image of the user by the at least one sensor, of a payment type intended for use by the user in a transaction using the payment machine.

26. (canceled)
